(19) United States
(12) Patent Application Publication
(10) Pub. No.: US 2023/0336436 A1
(43) Pub. Date: Oct. 19, 2023

(54) METHOD FOR SEMI-ASYNCHRONOUS FEDERATED LEARNING AND COMMUNICATION APPARATUS

(71) Applicant: HUAWEI TECHNOLOGIES CO., LTD., Shenzhen (CN)

(72) Inventors: Zhaoyang Zhang, Hangzhou (CN); Zhongyu Wang, Hangzhou (CN); Tianhang Yu, Hangzhou (CN); Jian Wang, Hangzhou (CN)

(73) Assignee: HUAWEI TECHNOLOGIES CO., LTD., Shenzhen (CN)

(21) Appl. No.: 18/331,929

(22) Filed: Jun. 8, 2023

Related U.S. Application Data
(63) Continuation of application No. PCT/CN2021/135463, filed on Dec. 3, 2021.

(30) Foreign Application Priority Data
Dec. 10, 2020 (CN) 202011437475.9

(51) Int. Cl. H04L 41/16; H04L 47/70; H04L 41/14

(52) U.S. Cl. CPC H04L 41/16; H04L 47/82; H04L 41/145

(57) ABSTRACT

This application provides a method for federated learning. A communication apparatus triggers, by setting a threshold (a time threshold and/or a count threshold), fusion of a local model sent by a terminal device, to generate a global model, and when a fusion weight of the local model is designed, a data feature included in the local model of the terminal device, a lag degree, and a utilization degree of a data feature of a sample set of the corresponding terminal device are comprehensively considered, so that a problem of low training efficiency caused by a synchronization requirement for model uploading versions in a synchronous system can be avoided, and a problem of unstable convergence and a poor generalization capability caused by an “update upon reception” principle of an asynchronous system can be avoided.

### CROSS-REFERENCE TO RELATED APPLICATIONS

This application is a continuation of International Application No. PCT/CN2021/135463, filed on Dec. 3, 2021, which claims priority to Chinese Patent Application No. 202011437475.9, filed on Dec. 10, 2020. The disclosures of the aforementioned applications are hereby incorporated by reference in their entireties.

### TECHNICAL FIELD

This application relates to the communication field, and specifically, to a method for semi-asynchronous federated learning and a communication apparatus.

### BACKGROUND

With advent of a big data era, each device generates a large amount of raw data in various forms every day. The data is generated in a form of “an island” and exists in every corner of the world. Conventional centralized learning requires that edge devices collectively transmit local data to a server of a central end, and then collected data is used for model training and learning. However, with development of the times, this architecture is gradually limited by the following factors: (1) The edge devices are widely distributed in various regions and corners of the world, and these devices continually generate and accumulate massive amounts of raw data at a fast speed. If the central end needs to collect raw data from all edge devices, huge communication loss and computing requirements are inevitably caused. (2) With complexity of actual scenarios in real life, more and more learning tasks require that the edge device can make timely and effective decisions and feedback. Conventional centralized learning involves upload of a large amount of data, inevitably causing a large degree of latency. As a result, the centralized learning cannot meet real-time requirements of actual task scenarios. (3) Industry competition, user privacy security, and complex administrative procedures are considered, and data centralization and integration will face increasing obstacles. Therefore, for system deployment, data is tended to be locally stored, and local computing of a model is completed by the edge device on its own.

Therefore, how to design a machine learning framework while meeting data privacy, security, and regulatory requirements to enable artificial intelligence (AI) systems to jointly use their data more efficiently and accurately becomes an important issue in current development of artificial intelligence. A concept of federated learning (FL) is proposed to effectively resolve difficulties faced by the current development of the artificial intelligence. While ensuring user data privacy and security, the federated learning facilitates the edge devices and the server of the central end to collaborate to efficiently complete learning tasks of the model. Although the proposed FL resolves problems in the current development of the artificial intelligence field to some extent, there are still some limitations existing in conventional synchronous and asynchronous FL frameworks.

### SUMMARY

This application provides a method for semi-asynchronous federated learning, which can avoid a problem of low training efficiency caused by a conventional synchronous system, and avoid a problem of unstable convergence and a poor generalization capability caused by an “update upon reception” principle of an asynchronous system.

According to a first aspect, a method for semi-asynchronous federated learning is provided, may be applied to a computing node, or may be applied to a component (e.g., a chip, a chip system, or a processor) in the computing node. The method includes: A computing node sends a first parameter to some or all of K subnodes in a t^{th} round of iteration, where the first parameter includes a first global model and a first timestamp t−1, the first global model is a global model generated by the computing node in a (t−1)^{th} round of iteration, t is an integer greater than or equal to 1, and the K subnodes are all subnodes that participate in model training. The computing node receives, in the t^{th} round of iteration, a second parameter sent by at least one subnode, where the second parameter includes a first local model and a first version number t′, the first version number indicates that the first local model is generated by the subnode through training, based on a local dataset, a global model received in a (t′+1)^{th} round of iteration, the first version number is determined by the subnode based on a timestamp received in the (t′+1)^{th} round of iteration, 1≤t′+1≤t, and t′ is a natural number. The computing node fuses, according to a model fusion algorithm, m received first local models when a first threshold is reached, to generate a second global model, and updates the first timestamp t−1 to a second timestamp t, where m is an integer greater than or equal to 1 and less than or equal to K. The computing node sends a third parameter to some or all subnodes of the K subnodes in a (t+1)^{th} round of iteration, where the third parameter includes the second global model and the second timestamp t.

In the foregoing technical solution, the computing node triggers fusion of a plurality of local models by setting a threshold (or a trigger condition), to avoid a problem of unstable convergence and a poor generalization capability caused by an “update upon reception” principle of an asynchronous system. In addition, the local model may be a local model generated by a client through training, based on the local dataset, a global model received in a current round or a global model received before the current round, so that a problem of low training efficiency caused by a synchronization requirement for model uploading versions in a conventional synchronous system may also be avoided.

Optionally, the second parameter may further include a device number corresponding to the subnode sending the second parameter.

With reference to the first aspect, in some implementations of the first aspect, the first threshold includes a time threshold L and/or a count threshold N, N is an integer greater than or equal to 1, the time threshold L is a preset quantity of time units configured to upload a local model in each round of iteration, and L is an integer greater than or equal to 1. That the computing node fuses, according to the model fusion algorithm, the m received first local models when the first threshold is reached includes: When the first threshold is the count threshold N, the computing node fuses, according to the model fusion algorithm, the m first local models received when the first threshold is reached, where m is greater than or equal to the count threshold N; when the first threshold is the time threshold L, the computing node fuses, according to the model fusion algorithm, m first local models received in L time units; or when the first threshold includes the count threshold N and the time threshold L, and either threshold of the count threshold N and the time threshold L is reached, the computing node fuses, according to the model fusion algorithm, the m received first local models.

With reference to the first aspect, in some implementations of the first aspect, the first parameter further includes a first contribution vector, and the first contribution vector includes contribution proportions of the K subnodes in the first global model. That the computing node fuses the m received first local models according to the model fusion algorithm, to generate a second global model includes: The computing node determines a first fusion weight based on the first contribution vector, a first sample proportion vector, and the first version number t′ corresponding to the m first local models, where the first fusion weight includes a weight of each local model of the m first local models upon model fusion with the first global model, and the first sample proportion vector includes a proportion of a local dataset of each subnode of the K subnodes in all local datasets of the K subnodes. The computing node determines the second global model based on the first fusion weight, the m first local models, and the first global model.

The method further includes: The computing node determines a second contribution vector based on the first fusion weight and the first contribution vector, where the second contribution vector is contribution proportions of the K subnodes in the second global model. The computing node sends the second contribution vector to some or all subnodes of the K subnodes in the (t+1)^{th} round of iteration.

In the fusion algorithm in the foregoing technical solution, a data characteristic included in the local model, a lag degree, and a utilization degree of a data feature of a sample set of a corresponding node are comprehensively considered. Based on the comprehensive consideration of various factors, each model may be endowed with a proper fusion weight, to ensure fast and stable convergence of the model.

With reference to the first aspect, in some implementations of the first aspect, before the computing node receives, in the t^{th} round of iteration, the second parameter sent by the at least one subnode, the method further includes: The computing node receives a first resource allocation request message from the at least one subnode, where the first resource allocation request message includes the first version number t′. When a quantity of the first resource allocation requests received by the computing node is less than or equal to a quantity of resources in a system, the computing node notifies, based on the first resource allocation request message, the at least one subnode to send the second parameter on an allocated resource; or when a quantity of the first resource allocation requests received by the computing node is greater than a quantity of resources in a system, the computing node determines based on the first resource allocation request message sent by the at least one subnode and the first proportion vector, a probability for a resource being allocated to each subnode of the at least one subnode. The computing node determines, based on the probability, to use a subnode of a resource in the system from the at least one subnode. The computing node gives a notification of determining to use the subnode of the resource in the system to send the second parameter on an allocated resource.

According to a central scheduling mechanism for local model uploading that is proposed in the foregoing technical solution, it can be ensured that the local model may use more data information with time validity may be used during fusion, to alleviate collision in an uploading process, reduce a transmission latency, and improve the training efficiency.

According to a second aspect, a method for semi-asynchronous federated learning is provided, may be applied to a subnode, or may be applied to a component (for example, a chip, a chip system, or a processor) in the subnode. The apparatus includes: The subnode receives a first parameter from a computing node in a t^{th} round of iteration, where the first parameter includes a first global model and a first timestamp t−1, the first global model is a global model generated by the computing node in a (t−1)^{th} round of iteration, and t is an integer greater than or equal to 1. The subnode trains, based on a local dataset, the first global model or a global model received before the first global model, to generate a first local model. The subnode sends a second parameter to the computing node in the t^{th} round of iteration, where the second parameter includes the first local model and a first version number t′, the first version number indicates that the first local model is generated by the subnode through training, based on the local dataset, a global model received in a (t′+1)^{th} round of iteration, the first version number is determined by the subnode based on a timestamp received in the (t′+1)^{th} round of iteration, 1≤t′+1≤t, and t′ is a natural number. The subnode receives a third parameter from the computing node in a (t+1)^{th} round of iteration, where the third parameter includes the second global model and a second timestamp t.

Optionally, the second parameter may further include a device number corresponding to the subnode sending the second parameter.

For technical effects of the second aspect, refer to descriptions in the first aspect. Details are not described herein again.

With reference to the second aspect, in some implementations of the second aspect, that the first local model is generated by the subnode through training, based on the local dataset, a global model received in the t^{′th} round of iteration includes: When the subnode is in an idle state, the first local model is generated by the subnode through training the first global model based on the local dataset; when the subnode is training a third global model, and the third global model is the global model received before the first global model, the first local model is generated by the subnode after choosing, based on an impact proportion of the subnode in the first global model, to continue training the third global model, or choosing to start training the first global model; or the first local model is a newest local model in at least one local model that is locally stored by the subnode and that has been trained but has not been successfully uploaded.

With reference to the second aspect, in some implementations of the second aspect, the first parameter further includes a first contribution vector, and the first contribution vector includes contribution proportions of the K subnodes in the first global model. That the first local model is generated by the subnode after choosing, based on an impact proportion of the subnode in the first global model, to continue training the third global model, or choosing to start training the first global model includes: When a ratio of a contribution proportion of the subnode in the first global model to a sum of the contribution proportions of the K subnodes in the first global model is greater than or equal to the first sample proportion, the subnode stops training the third global model, and starts training the first global model, where the first sample proportion is a ratio of the local dataset of the subnode to all local datasets of the K subnodes; or when a ratio of a contribution proportion of the subnode in the first global model to a sum of the contribution proportions of the K subnodes in the first global model is less than the first sample proportion, the subnode continues training the third global model.

The method further includes: The subnode receives the second contribution vector from the computing node in the (t+1)^{th} round of iteration, where the second contribution vector is contribution proportions of the K subnodes in the second global model.

With reference to the second aspect, in some implementations of the second aspect, before the subnode sends, in the t^{th} round of iteration, the second parameter to the computing node, the method further includes: The subnode sends a first resource allocation request message to the computing node, where the first resource allocation request message includes the first version number t′. The subnode receives a notification about a resource allocated by the computing node, and the subnode sends the second parameter on the allocated resource based on the notification.

According to a third aspect, this application provides a communication apparatus. The communication apparatus has functions of implementing the method according to the first aspect or any possible implementation of the first aspect. The functions may be implemented by hardware, or may be implemented by hardware executing corresponding software. The hardware or the software includes one or more units corresponding to the foregoing functions.

In an example, the communication apparatus may be a computing node.

In another example, the communication apparatus may be a component (e.g., a chip or an integrated circuit) mounted in the computing node.

According to a fourth aspect, this application provides a communication apparatus. The communication apparatus has functions of implementing the method according to the second aspect or any possible implementation of the second aspect. The functions may be implemented by hardware, or may be implemented by hardware executing corresponding software. The hardware or the software includes one or more units corresponding to the foregoing functions.

In an example, the communication apparatus may be a subnode.

In another example, the communication apparatus may be a component (e.g., a chip or an integrated circuit) mounted in the subnode.

According to a fifth aspect, this application provides a communication device, including at least one processor. The at least one processor is coupled to at least one memory, the at least one memory is configured to store a computer program or instructions and the at least one processor is configured to invoke the computer program or the instructions from the at least one memory and run the computer program or the instructions, and the communication device is enabled to perform the method according to the first aspect or any possible implementation of the first aspect.

In an example, the communication apparatus may be a computing node.

In another example, the communication apparatus may be a component (e.g., a chip or an integrated circuit) mounted in the computing node.

According to a sixth aspect, this application provides a communication device, including at least one processor. The at least one processor is coupled to at least one memory, the at least one memory is configured to store a computer program or instructions, and the at least one processor is configured to invoke the computer program or the instructions from the at least one memory and run the computer program or the instructions, and the communication device is enabled to perform the method according to the second aspect or any possible implementation of the second aspect.

In an example, the communication apparatus may be a subnode.

In another example, the communication apparatus may be a component (for example, a chip or an integrated circuit) mounted in the subnode.

According to a seventh aspect, a processor is provided, including an input circuit, an output circuit, and a processing circuit. The processing circuit is configured to receive a signal through the input circuit, and transmit a signal through the output circuit, to implement the method according to the first aspect or any possible implementation of the first aspect.

In a specific implementation process, the processor may be a chip, the input circuit may be an input pin, the output circuit may be an output pin, and the processing circuit may be a transistor, a gate circuit, a trigger, various logic circuits, or the like. The input signal received by the input circuit may be received and input by, for example, but not limited to, a receiver, the signal output by the output circuit may be output to, for example, but not limited to, a transmitter and transmitted by the transmitter, and the input circuit and the output circuit may be a same circuit, where the circuit is used as the input circuit and the output circuit at different moments. Specific implementations of the processor and the various circuits are not limited in embodiments of this application.

According to an eighth aspect, a processor is provided. The processor includes an input circuit, an output circuit, and a processing circuit. The processing circuit is configured to receive a signal through the input circuit, and transmit a signal through the output circuit, to implement the method according to the second aspect or any possible implementation of the second aspect.

In a specific implementation process, the processor may be a chip, the input circuit may be an input pin, the output circuit may be an output pin, and the processing circuit may be a transistor, a gate circuit, a trigger, various logic circuits, or the like. The input signal received by the input circuit may be received and input by, for example, but not limited to, a receiver, the signal output by the output circuit may be output to, for example, but not limited to, a transmitter and transmitted by the transmitter, and the input circuit and the output circuit may be a same circuit, where the circuit is used as the input circuit and the output circuit at different moments. Specific implementations of the processor and the various circuits are not limited in embodiments of this application.

According to a ninth aspect, this application provides a computer-readable storage medium. The computer-readable storage medium stores computer instructions, and when the computer instructions are run on a computer, the method according to the first aspect or any possible implementation of the first aspect is performed.

According to a ninth aspect, this application provides a computer-readable storage medium. The computer-readable storage medium stores computer instructions, and when the computer instructions are run on a computer, the method according to the second aspect or any possible implementation of the second aspect is performed.

According to an eleventh aspect, this application provides a computer program product. The computer program product includes computer program code, and when the computer program code is run on a computer, the method according to the first aspect or any possible implementation of the first aspect is performed.

According to a twelfth aspect, this application provides a computer program product. The computer program product includes computer program code, and when the computer program code is run on a computer, the method according to the second aspect or any possible implementation of the second aspect is performed.

According to a thirteenth aspect, this application provides a chip including a processor and a communication interface. The communication interface is configured to receive a signal and transmit the signal to the processor, and the processor processes the signal, to perform the method according to the first aspect or any possible implementation of the first aspect.

According to a fourteenth aspect, this application provides a chip including a processor and a communication interface. The communication interface is configured to receive a signal and transmit the signal to the processor, and the processor processes the signal, to perform the method according to the second aspect or any possible implementation of the second aspect.

According to a fifteenth aspect, this application provides a communication system, including the communication device according to the fifth aspect and the communication device according to the sixth aspect.

### BRIEF DESCRIPTION OF DRAWINGS

FIG. 1 is a schematic diagram of a communication system to which an embodiment of this application is applicable;

FIG. 2 is a schematic diagram of a system architecture for semi-asynchronous federated learning to which this application is applicable;

FIG. 3 is a schematic flowchart of a method for semi-asynchronous federated learning according to this application;

FIG. 4 (a) and FIG. 4 (b) are working sequence diagrams depicting that a central end is triggered, in a manner of setting a count threshold N=3, to perform model fusion in a semi-asynchronous FL system including one central server and five clients according to this application;

FIG. 5 is a working sequence diagram depicting that a central end is triggered, in a manner of setting a time threshold L=1, to perform model fusion in a semi-asynchronous FL system including one central server and five clients according to this application;

FIG. 6 is a division diagram of system transmission slots that is applicable to this application;

FIG. 7 is a flowchart of scheduling system transmission slots according to this application;

FIG. 8 (a), FIG. 8 (b), FIG. 8 (c), and FIG. 8 (d) are simulation diagrams of a training set loss and accuracy and a test set loss and accuracy that change with a training time in a semi-asynchronous FL system with a set count threshold N and a conventional synchronous FL framework according to this application;

FIG. 9 is a simulation diagram of a training set loss and accuracy and a test set loss and accuracy that change with a training time in a semi-asynchronous federated learning system with a set time threshold L and a conventional synchronous FL framework according to this application;

FIG. 10 is a schematic block diagram of a communication apparatus 1000 according to this application;

FIG. 11 is a schematic block diagram of a communication apparatus 2000 according to this application;

FIG. 12 is a schematic diagram of a structure of a communication apparatus 10 according to this application; and

FIG. 13 is a schematic diagram of a structure of a communication apparatus 20 according to this application.

### DETAILED DESCRIPTION

The following describes technical solutions of this application with reference to accompanying drawings.

The technical solutions in embodiments of this application may be applied to various communication systems, such as a global system for mobile communication (GSM), a code division multiple access (CDMA) system, a wideband code division multiple access (WCDMA) system, a general packet radio service (GPRS) system, a long term evolution (LTE) system, an LTE frequency division duplex (FDD) system, an LTE time division duplex (TDD) system, a universal mobile telecommunication system (UMTS), a worldwide interoperability for microwave access (WiMAX) communication system, a 5th generation (5G) system or a new radio (NR) system, a device-to-device (D2D) communication system, a machine communication system, an internet of vehicles communication system, a satellite communication system, or a future communication system.

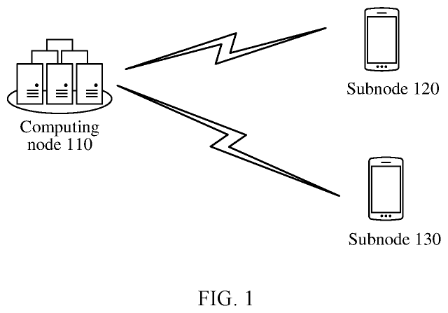

For ease of understanding of embodiments of this application, a communication system to which an embodiment of this application is applicable is first described with reference to FIG. 1. The communication system may include a computing node 110 and a plurality of subnodes, for example, a subnode 120 and a subnode 130.

In this embodiment of this application, the computing node may be any device that has a wireless transceiver function. The computing node includes but is not limited to: an evolved NodeB (evolved NodeB, eNB), a radio network controller (RNC), a NodeB (NodeB, NB), a home base station (e.g., a home evolved NodeB, or a home NodeB, HNB), a baseband unit (BBU), an access point (AP) in a wireless fidelity (Wi-Fi) system, a wireless relay node, a wireless backhaul node, a transmission point (TP), a transmission and reception point (TRP), or the like, and may alternatively be a gNB or a transmission point (TRP or TP) in a 5G (e.g., NR) system, or one or a group of (including a plurality of antenna panels) antenna panels of a base station in the 5G system, or a network node, for example, a baseband unit (BBU), that constitutes a gNB or a transmission point, or a distributed unit (DU).

In this embodiment of this application, the subnode may be user equipment (UE), an access terminal, a subscriber unit, a subscriber station, a mobile station, a mobile console, a remote station, a remote terminal, a mobile device, a user terminal, a terminal, a wireless communication device, a user agent, or a user apparatus. The terminal device in this embodiment of this application may be a mobile phone (mobile phone), a tablet computer (pad), a computer having a wireless transceiver function, a virtual reality (VR) terminal device, an augmented reality (AR) terminal device, a wireless terminal in industrial control (industrial control), a wireless terminal in self-driving (self-driving), a wireless terminal in remote medical (remote medical), a wireless terminal in a smart grid (smart grid), a wireless terminal in transportation safety (transportation safety), a wireless terminal in a smart city (smart city), a wireless terminal in a smart home (smart home), a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, a vehicle-mounted device, a wearable device, a terminal device in a 5G network, a terminal device in a non-public network, or the like.

The wearable device may also be referred to as a wearable intelligent device, and is a general term of wearable devices, such as glasses, gloves, watches, clothes, and shoes, that are developed by applying wearable technologies to intelligent designs of daily wear. The wearable device is a portable device that can be directly worn on the body or integrated into clothes or an accessory of a user. The wearable device is not only a hardware device, but also implements a powerful function through software support, data exchange, and cloud interaction. Generalized wearable intelligent devices include full-featured and large-size devices that can implement complete or partial functions without depending on smartphones, such as smart watches or smart glasses, and devices that focus on only one type of application function and need to work with other devices such as smartphones, such as various smart bands or smart jewelry for monitoring physical signs.

In addition, the computing node and the subnode may alternatively be terminal devices in an Internet of Things (IoT) system. An IoT is an important part in future development of information technologies. A main technical feature of the IoT is to connect things to a network via a communication technology, to implement an intelligent network for human-machine interconnection and thing-thing interconnection.

It should be understood that, the foregoing descriptions do not constitute a limitation on the computing node and the subnode in this application. Any device or internal component (e.g., a chip or an integrated circuit) that can implement a central end function in this application may be referred to as a computing node, and any device or internal component (e.g., a chip or an integrated circuit) that can implement a client function in this application may be referred to as a subnode.

For ease of understanding embodiments of this application, a conventional synchronous FL architecture and asynchronous FL architecture are first briefly described.

The synchronous FL architecture is the most widely used training architecture in the FL field. A FedAvg algorithm is a basic algorithm proposed in the synchronous FL architecture. An algorithm process of the FedAvg algorithm is as follows:
(1) A central end initializes a to-be-trained model w_{g}⁰ and broadcasts the model to all client devices.
(2) In a t^{th}∈[1, T] round, a client k∈[1, K] trains a received global model w_{g}^{t-1} based on a local dataset [symbol] ₖ for E epochs, to obtain a local training result wₖ^{t}.
(3) A server of the central end collects and summarizes local training results from all (or some) clients. Assuming that a set of clients that upload local models in the t^{th} round is [symbol] ′, the central end performs weighted average using a quantity Dₖ of samples of the local dataset [symbol] ₖ of the client k as a weight, to obtain a new global model. A specific update rule is

$${w}_{g}^{t} = {\sum }_{k ∈ {ℜ}^{t}} \frac{{D}_{k} {w}_{k}^{t}}{{\sum }_{k ∈ {ℜ}^{t}} {D}_{k}} .$$

Then, the central end broadcasts the global model w_{g}^{t} of a newest version to all client devices to perform a new round of training.

(4) Steps (2) and (3) are repeated until the model is converged finally or a quantity of training rounds reaches an upper limit.

Although the synchronous FL architecture is simple and ensures an equivalent computing model, after each round of local training is ended, uploading local models by a large number of users leads to huge instantaneous communication load, easily causing network congestion. In addition, different client devices may have a large difference in attributes such as a communication capability, a computing capability, and a sample proportion. With reference to the “buckets effect”, it can be learned that if synchronization between client groups in the system is overemphasized, overall training efficiency of the FL will be greatly reduced due to some devices with poor performance.

Compared with the conventional synchronous architecture, an absolute asynchronous FL architecture weakens a synchronization requirement of the central end for client model uploading. Inconsistency between the local training results of the clients is fully considered and used in the asynchronous FL architecture, and a proper central-end update rule is designed to ensure reliability of the training results. A FedAsync algorithm is a basic algorithm proposed in the absolute asynchronous FL architecture. An algorithm process of the FedAsync algorithm is as follows:
(1) A central end initializes a to-be-trained model w_{g}⁰, a smoothing coefficient is α, and a timestamp is τ=0 (which may be understood as a quantity of times for which the central end performs model fusion).
(2) A server of the central end broadcasts an initial global model to some client devices. When sending the global model, the server of the central end additionally notifies a corresponding client of a timestamp τ in which the model is sent.
(3) For a client k∈[1, K], if successfully receiving the global model w_{g}^{τ} sent by the central end, the client k records τₖ=τ and trains the received global model w_{g}^{τ} based on a local data set [symbol] ₖ for E epochs, to obtain a local training result wₖ^{τ}^{ₖ}. Then, the client k uploads an information pair (wₖ^{τ}^{ₖ},τₖ) to the server of the central end.
(4) Once receiving the information pair (wₖ^{τ}^{ₖ},τₖ) from any client, the server of the central end immediately fuses the global model in a manner of moving average*. Assuming that a current timestamp is t, and an update rule of the global model of the central end is w_{g}^{t+1}=(1−αₜ)w_{g}^{t}+αₜwₖ^{τ}^{ₖ}, αₜ=α×s(t−τₖ), and s (·) is a decreasing function indicating that as a time difference increases, the central end endows a lower weight to a corresponding local model. Then, after the central end obtains a new global model, the timestamp is increased by 1, and a scheduling thread on the central end immediately randomly sends the newest global model and a current timestamp to some idle clients to start a new round of training process.
(5) A system performs steps (3) and (4) in parallel until the model is converged finally or a quantity of training rounds reaches an upper limit.

Compared with the conventional synchronous FL architecture, the asynchronous architecture effectively avoids the synchronization requirement between clients, but still has some technical defects. The central end delivers the global model to some nodes by broadcasting in a manner of random selection, resulting in wastes of idle computing resources and incomplete use of node data characteristics by the system to some extent. The central end complies with an “update upon reception” principle when performing model fusion, stable convergence of the model cannot be ensured, and strong oscillation and uncertainty are easily introduced. A node with a large capacity of local dataset has a large version difference in training results due to an excessively long training time. As a result, a fusion weight of the local model is always excessively small, and finally a data characteristic of the node cannot be reflected in the global model, and the global model does not have a good generalization capability.

In view of this, this application provides a semi-asynchronous FL architecture, to comprehensively consider factors such as data characteristics and communication frequencies of the nodes, and lags of local models of the nodes to different degrees, so as to alleviate problems of heavy communication load and low learning efficiency that are faced by the conventional synchronous FL architecture and asynchronous FL architecture.

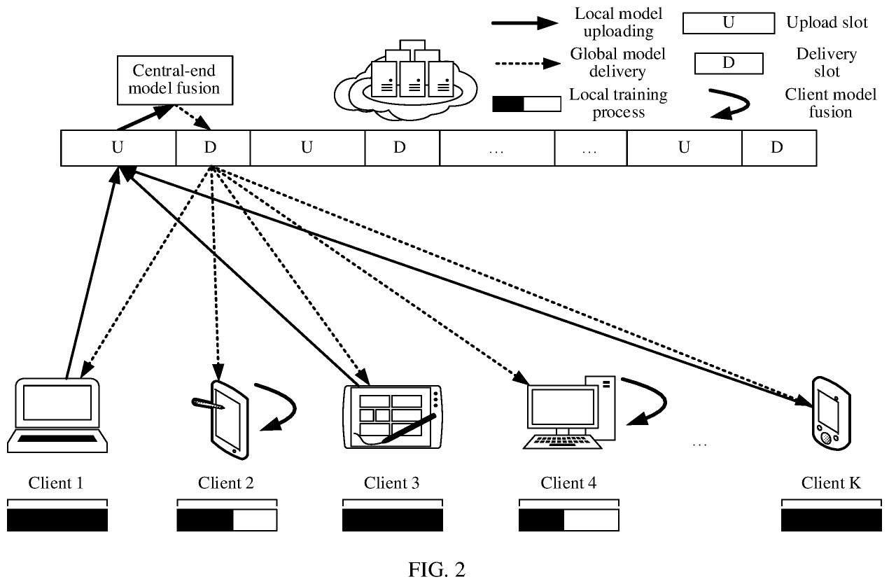

FIG. 2 is a schematic diagram of a system architecture for semi-asynchronous federated learning to which this application is applicable.

As shown in FIG. 2, K clients (that is, an example of subnodes) are connected to a central end (that is, an example of a computing node), and a central server and the clients may transmit data to each other. Each client has its own independent local dataset. A client k in the K clients is used as an example. The client k has a dataset [symbol] ₖ{(x_{k,1},y_{k,1}),(x_{k,2},y_{k,2}), . . . ,(x_{k,i},y_{k,i}), . . . ,(x_{k,D}_{ₖ},y_{k,D}_{ₖ})}, x_{k,i} represents an i^{th} piece of sample data of the client k, y_{k,i} represents a real label of a corresponding sample, and Dₖ is a quantity of samples of the local dataset of the client k.

An orthogonal frequency division multiple access (orthogonal frequency division multiple access, OFDMA) technology is used in an uplink in a cell, and it is assumed that a system includes n resource blocks in total, and a bandwidth of each resource block is B^{U}. A path loss between each client device and the server is Lₚₐₜₕ (d), d represents a distance between the client and the server (assuming that a distance between the k^{th} client and the server is dₖ), and a channel noise power spectral density is set to N₀. In addition, it is assumed that a to-be-trained model in the system includes S parameters in total, and each parameter is quantized into q bits during transmission. Correspondingly, when the server delivers a global model by broadcasting, an available bandwidth may be set to B, and transmit powers of the server and each client device are respectively Pₛ and P_{c}. It is assumed that an iteration period of each local training performed by the client is E epochs, each sample needs to consume C floating-point operations during training, and a CPU frequency of each client device is f.

The central end divides a training process into alternate upload slots and download slots along a timeline based on a preset rule. The upload slots may include a plurality of upload sub-slots, and a quantity of upload sub-slots is changeable. A length of a single upload slot and a length of a single download slot may be determined as the following method:

An uplink channel SNR between the client k and the server is: ρₖ=P_{c}−Lₚₐₜₕ(dₖ)−N₀B^{U}.

A time required for the client to upload a local training result using a single resource block is:

$${t}_{k}^{U} = \frac{qS}{{B}^{U} log ( 1 + {ρ}_{k} )} .$$

A time required for the client to perform local training of E epochs is:

$${t}_{k}^{l} = \frac{{D}_{k} EC}{{f}_{k}} .$$

A minimum SNR value of a downlink broadcast channel between the server and the client is:

$${ρ}^{′} = {min}_{k = 1 , 2 , … , K} {P}_{s} - {L}_{path} ( {d}_{k} ) - {N}_{0} B .$$

A time consumed by the server to deliver the global model by broadcasting is:

$${t}_{k}^{D} = \frac{qS}{B log ( 1 + {ρ}^{′} )} .$$

A centralized proportion of the local data set of the client k in an overall data set is:

$${β}_{k} = \frac{{D}_{k}}{{\sum }_{i = 1}^{K} {D}_{i}} .$$

To ensure that the client can send the local model to the central end in one upload sub-slot once successfully preempting a resource block, a time length of a single upload sub-slot is set to

$${T}^{U} = {max}_{k = 1 , 2 , … , K} {t}_{k}^{U} ,$$

and a length of a single download slot is T^{D}=tₖ^{D},∀k=1, 2, . . . , K.

The following describes the technical solution of this application in detail.

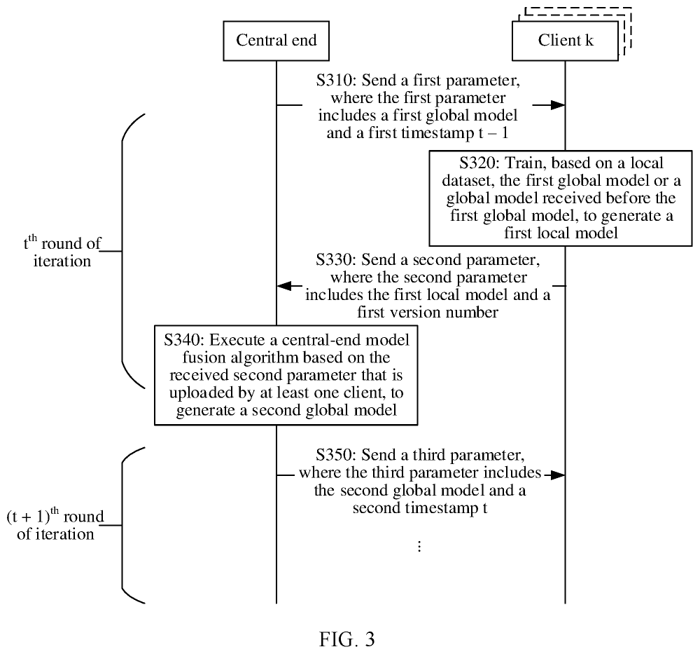

FIG. 3 is a schematic flowchart of a method for semi-asynchronous federated learning according to this application.

In a start phase of training, a central end needs to initialize a global model w_{g}⁰, and a timestamp is τ=0.

Optionally, the central end initializes a contribution vector s⁰=[s₁⁰,s₂⁰, . . . ,sₖ⁰, . . . ,sₖ⁰]=[0,0, . . . ,0], and sₖ⁰ represents a contribution proportion of a client k in the global model w_{g}⁰.

S310: Starting from a t^{th} round of iteration, where t is an integer greater than or equal to 1, the central end sends a first parameter to all or some clients of K clients in a single download slot. For ease of description, an example in which the central end sends the first parameter to the client k is used for description.

Correspondingly, the client k receives the first parameter from the central end in a download slot corresponding to the t^{th} round of iteration.

It should be noted that, the client k may alternatively choose, based on a current state, not to receive the first parameter delivered by the central end. Whether the client k receives the first parameter is not described herein. For details, refer to the description in S320.

The first parameter includes a first global model w_{g}^{t-1} and a current timestamp τ=t−1 (that is, a first timestamp), and the first global model is a global model generated by a central server in a (t−1)^{th} round of iteration. It should be noted that, when t=1, that is, in a first round of iteration, the first global model sent by the central end to the client k is the global model w_{g}⁰ initialized by the central end.

Optionally, the first parameter includes a first contribution vector s^{t-1}=[s₁^{t-1},s₂^{t-1}, . . . ,sₖ^{t-1}, . . . ,s_{K}^{t-1}], and sₖ^{t-1} represents the contribution proportion of the client k in the global model w_{g}^{t-1}.

S320: The client k trains, based on a local dataset, the first global model or a global model received before the first global model, to generate a first local model.

1. If the client k is in an idle state, the client k immediately trains the received first global model w_{g}^{t-1} using the local dataset [symbol] ₖ, to generate the first local model, and updates a first version number tₖ=τ=t−1, the first version number tₖ indicates that the first local model is generated by the client k through training, based on the local dataset, a global model received in (tₖ+1)^{th} iteration. In other words, the first version number tₖ=τ=t−1 indicates that the global model based on which the first local model is trained is obtained by receiving in a t (version number+1)^{th} round of delivery.

2. If the client k is continuing training an outdated global model (that is, a third global model), a decision is made by measuring a relationship between a current impact proportion of the client k in the first global model (that is, a newest received global model) and a sample quantity proportion of the client k.

If

$$\frac{{s}_{k}^{t - 1}}{{\sum }_{i = 1}^{K} {s}_{i}^{t - 1}} \geq {β}_{k} ,$$

the client k abandons a model that is being trained, starts to train the newly received first global model to generate the first local model, and simultaneously updates the first version number tₖ; or if

$$\frac{{s}_{k}^{t - 1}}{{\sum }_{i = 1}^{K} {s}_{i}^{t - 1}} < {β}_{k} ,$$

the client k continues to train the third global model to generate a first local model, and updates a first version number tₖ.

It should be understood that, the updated first version number corresponding to the first local model generated by the client k using the first global model is different from that corresponding to the first local model generated by the client k using the third model. Details are not described herein again.

Optionally, the client k may first determine whether to continue training the third global model, and then choose, based on a determination result, whether to receive the first parameter delivered by the central end.

3. If the client k locally stores, in this round, at least one local model that has been trained but has not been successfully uploaded, the client k makes a decision by measuring the relationship between the current impact proportion of the client k in the first global model (that is, the newest received global model) and the sample quantity proportion of the client k.

If

$$\frac{{s}_{k}^{t - 1}}{{\sum }_{i = 1}^{K} {s}_{i}^{t - 1}} \geq {β}_{k} ,$$

the client k abandons the model that has been trained, trains the newly received first global model to generate a first local model, and simultaneously updates a first version number tₖ; if

$$\frac{{s}_{k}^{t - 1}}{{\sum }_{i = 1}^{K} {s}_{i}^{t - 1}} < {β}_{k} ,$$

the client k selects, from the local models that have been trained, a local model that is most newly trained as a first local model uploaded in the current round, and simultaneously updates a first version number tₖ corresponding to a global model based on which the first local model is generated through training. The client k attempts to randomly access a resource block at an initial moment of a single upload sub-slot. If only the client k selects the resource block, it is considered that the client k successfully uploads the local model; or if conflicts occur in the resource block, it is considered that the client k fails to perform uploading, and the client k needs to attempt retransmission in other remaining upload sub-slots of the current round.

It should be noted that, the client k is allowed to successfully upload the local model only once in each round, and always preferentially uploads a local model that is most newly trained.

S330: The client k sends a second parameter to the central end in the t^{th} round of iteration.

Correspondingly, the central end receives, in the t^{th} round of iteration, the second parameter sent by at least one client.

The second parameter includes the first local model and the first version number tₖ, the first version number indicates that the first local model is generated by the client k through training, based on the local dataset, a global model received in a (tₖ+1)^{th} round of iteration, and the first version number is determined by the client k based on a timestamp received in the (tₖ+1)^{th} round of iteration, 1≤tₖ+1≤t, and tₖ is a natural number.

Optionally, the second parameter further includes a device number of the client k.

S340: The central end executes a central-end model fusion algorithm based on the received second parameter (that is, a local training result of each client) that is uploaded by the at least one client, to generate a second global model.

When the central server is triggered to perform model fusion, the central server fuses m received first local models according to the model fusion algorithm, to generate the second global model, and updates the timestamp to =t (that is, a second timestamp), 1≤m≤K, and m is an integer.

As an example instead of a limitation, this application provides several triggering manners for the central end to perform model fusion.

Manner one: The central server may trigger, in a manner of setting a count threshold (that is, an example of a first threshold), the central end to perform model fusion.

For example, the central server continuously receives, in subsequent several upload sub-slots, local training results

$$( {k}_{i}^{t} , {w}_{{k}_{i}^{t}}^{t} , {t}_{i} ) ,$$

i=1, 2, . . . ,m uploaded by m different clients. When m≥N, where N is a count threshold preset by the central end, the central-end model fusion algorithm is performed to obtain a fused model and an updated contribution vector, where 1≤N≤K, and N is an integer.

$$( {k}_{i}^{t} , {w}_{{k}_{i}^{t}}^{t} , {t}_{i} )$$

indicates that a client kᵢ^{t} (ID) uploads a local training result

$${w}_{{k}_{i}^{t}}^{t}$$

(local model) thereof in me current round (that is, the t^{th} round), and a global model based on which the local model is trained is received in a (tᵢ+1)^{th} (that is, version number+1) round of delivery.

For example, this application provides a derivation process of the central-end model fusion algorithm. The central server needs to determine fusion weights of m+1 models, including m local models wₖ_{ᵢ}_{^{t}}^{t}—1, 2, . . . , m) and a global model w_{g}^{t-1} obtained by updating by the central end in a previous round. The central end first constructs the contribution matrix as follows:

$${X}^{t} = [ \begin{matrix}{λ}^{t - {t}_{1} - 1} \cdot {h}^{{t}_{1}} & 1 - {λ}^{t - {t}_{1} - 1} \\ {λ}^{t - {t}_{2} - 1} \cdot {h}^{{t}_{2}} & 1 - {λ}^{t - {t}_{2} - 1} \\ ⋮ & ⋮ \\ {λ}^{t - {t}_{m} - 1} \cdot {h}^{{t}_{m}} & 1 - {λ}^{t - {t}_{m} - 1} \\ λ {t}^{\frac{N}{K}} {s}^{t - 1} & ( 1 - λ ) {t}^{\frac{N}{K}}\end{matrix} ] = [ \begin{matrix}0 & … & {λ}^{t - {t}_{1} - 1} \cdot 1 & … & 0 & … & 0 & … & 0 & 1 - {λ}^{t - {t}_{1} - 1} \\ 0 & … & 0 & … & {λ}^{t - {t}_{2} - 1} \cdot 1 & … & 0 & … & 0 & 1 - {λ}^{t - {t}_{2} - 1} \\ ⋮ & ⋱ & ⋮ & ⋱ & ⋮ & ⋱ & ⋮ & ⋱ & ⋮ & ⋮ \\ 0 & … & 0 & … & 0 & … & {λ}^{t - {t}_{m} - 1} \cdot 1 & … & 0 & 1 - {λ}^{t - {t}_{m} - 1} \\ λ {t}^{\frac{N}{K}} {s}_{1}^{t - 1} & … & λ {t}^{\frac{N}{K}} {s}_{{k}_{1}^{t}}^{t - 1} & … & λ {t}^{\frac{N}{K}} {s}_{{k}_{2}^{t}}^{t - 1} & … & λ {t}^{\frac{N}{K}} {s}_{{k}_{m}^{t}}^{t - 1} & … & λ {t}^{\frac{N}{K}} {s}_{K}^{t - 1} & ( 1 - λ ) {t}^{\frac{N}{K}}\end{matrix} ]$$

A value of h is a one hot vector, a corresponding position is 1, and other positions are all 0. First m rows of the contribution matrix correspond to the m local models, and a last row corresponds to the global model generated in the previous round. First K columns in each row indicate a proportion of valid data information of K clients in a corresponding model, and a last column indicates a proportion of outdated information in the corresponding model.

$$λ = 1 - \frac{N}{K}$$

is a version attenuation factor, and represents a proportion of information of a local model obtained in (t−1)^{th} round of training that still has time validity when the local model participates in a t^{th} round of central-end fusion.

When measuring a proportion of a data feature of each client that is contained in the local model, an “independence” assumption is proposed. Specifically, after the model is fully trained based on data of a client, the central end determines that a data feature of the client plays an absolute dominant role in a corresponding local model (which is reflected as a one hot vector in the contribution matrix). However, the “independence” assumption gradually weakens as the model converges (to be specific, in the contribution matrix, elements in the last row gradually accumulate as a quantity of training rounds increases, and the global model gradually dominates as the training progresses). In the contribution matrix, a total impact of the global model of the central end increases as the quantity of training rounds increases. Specifically, a total impact of the global model of the central end in the t^{th} round is tN/K, is a count threshold preset by the central end, and K is a total quantity of clients in the system.

Assuming that a fusion weight of the current round is at α^{t}={α₀^{t},α₁^{t}, α₂^{t}, . . . ,αₘ^{t}}, after the central end performs model fusion, an impact proportion of the client kit in the updated global model is

$${γ}_{{k}_{i}^{t}} = \frac{{α}_{0}^{t} λ {s}_{{k}_{i}^{t}}^{t - 1} {t}^{\frac{N}{K}} + {α}_{i}^{t} {λ}^{t - {t}_{i} - 1}}{{α}_{0}^{t} {t}^{\frac{N}{K}} + {\sum }_{l = 1}^{m} {α}_{l}^{t}} ,$$

i=1, 2, . . . , m. In addition, in this application, ζₜ={k₁^{t},k₂^{t}, . . . ,kₘ^{t}} is used to represent a set of clients that upload local training results in this round (that is, the t^{th} round), and the central end further measures a contribution proportion

$${\hat{γ}}_{{k}_{i}^{t}} = \frac{{α}_{0}^{t} λ {s}_{{k}_{i}^{t}}^{t - 1} {t}^{\frac{N}{K}} + {α}_{i}^{t} {λ}^{t - {t}_{i} - 1}}{{α}_{0}^{t} {t}^{\frac{N}{K}} ( 1 - λ + λ {\sum }_{j = 1}^{m} {s}_{{k}_{j}^{t}}^{t - 1} ) + {\sum }_{l = 1}^{m} {α}_{l}^{t}} ,$$

i=1,2, . . . ,m of each client that uploads a local model in this round in the set and a sample proportion of each client in the set

$${\hat{β}}_{{k}_{i}^{t}} = \frac{{β}_{{k}_{i}^{t}}}{{\sum }_{j = 1}^{m} {β}_{{k}_{j}^{t}}} ,$$

i=1,2, . . . ,m. In addition, from a global perspective of the system and a perspective of communication node set of this round, proportions of outdated information introduced by the system are respectively

$${γ}_{0} = \frac{{α}_{0}^{t} ( 1 - λ ) {t}^{\frac{N}{K}} + {\sum }_{i = 1}^{m} {α}_{i}^{t} ( 1 - {λ}^{t - {t}_{i} - 1} )}{{α}_{0}^{t} {t}^{\frac{N}{K}} + {\sum }_{l = 1}^{m} {α}_{l}^{t}} and \\ {\hat{γ}}_{0} = \frac{{α}_{0}^{t} ( 1 - λ ) {t}^{\frac{N}{K}} + {\sum }_{i = 1}^{m} {α}_{i}^{t} ( 1 - {λ}^{t - {t}_{i} - 1} )}{{α}_{0}^{t} {t}^{\frac{N}{K}} ( 1 - λ + λ {\sum }_{j = 1}^{m} {s}_{{k}_{j}^{t}}^{t - 1} ) + {\sum }_{l = 1}^{m} {α}_{l}^{t}} .$$

From the global perspective and the perspective of the communication node set, the following optimization problem is constructed in this application:

$${min}_{{α}^{t}} φ {‖ \hat{γ} - \hat{β} ‖}_{2}^{2} + ( 1 - φ ) {‖ γ - β ‖}_{2}^{2}$$

A value of a bias coefficient φ of an optimization objective is 0<φ<1,

$$s . t . {\sum }_{i = 0}^{m} {α}_{i}^{t} = 1 ,$$

αᵢ^{t}≥0, 1, 2, . . . , m, and

$$γ = [ \begin{matrix}{γ}_{{k}_{1}^{t}} \\ {γ}_{{k}_{2}^{t}} \\ ⋮ \\ {γ}_{{k}_{m}^{t}} \\ {γ}_{0}\end{matrix} ] ∈ {R}^{( m + 1 ) \times 1} , \hat{γ} = [ \begin{matrix}{\hat{γ}}_{{k}_{1}^{t}} \\ {\hat{γ}}_{{k}_{2}^{t}} \\ ⋮ \\ {\hat{γ}}_{{k}_{m}^{t}} \\ {\hat{γ}}_{0}\end{matrix} ] ∈ {R}^{( m + 1 ) \times 1} , \\ β = [ \begin{matrix}{β}_{{k}_{1}^{t}} \\ {β}_{{k}_{2}^{t}} \\ ⋮ \\ {β}_{{k}_{m}^{t}} \\ 0\end{matrix} ] ∈ {R}^{( m + 1 ) \times 1} , \hat{β} = [ \begin{matrix}{\hat{β}}_{{k}_{1}^{t}} \\ {\hat{β}}_{{k}_{2}^{t}} \\ ⋮ \\ {\hat{β}}_{{k}_{m}^{t}} \\ 0\end{matrix} ] ∈ {R}^{( m + 1 ) \times 1} .$$

A final fusion weight α^{t}={α₀^{t},α₁^{t},α₂^{t}, . . . ,αₘ^{t}} of the t^{th} round may be obtained by solving the foregoing optimization problem. Then, the central server completes updates on the global model and contribution vectors of all client. The updated global model w_{g}^{t} (that is, the second global model) and contribution vectors s^{t}=[s₁^{t},s₂^{t}, . . . ,sₖ, . . . ,s_{K}^{t}] (that is, second contribution vectors) are shown as follows, and sₖ^{t} represents a contribution proportion of the client k in the global model w_{g}^{t}.

$${w}_{g}^{t} = {α}_{0}^{t} {w}_{g}^{t - 1} + {\sum }_{i = 1}^{m} {α}_{i}^{t} {w}_{{k}_{i}^{t}}^{t} \\ {s}_{k}^{t} = {α}_{0}^{t} \frac{{s}_{k}^{t - 1}}{{\sum }_{j = 1}^{K} {s}_{j}^{t - 1}} + {\sum }_{i = 1}^{m} {α}_{i}^{t} II ( k == {k}_{i}^{t} ) , k = 1 , 2 , … , K$$

II (·) is an indicator function, and indicates that a value of II (·) is 1 when a condition in parentheses is met, or is 0 when the condition in parentheses is not met. After obtaining a new global model, the central server updates the current timestamp. Specifically, the current timestamp is increased by 1, and an updated timestamp is τ=t.

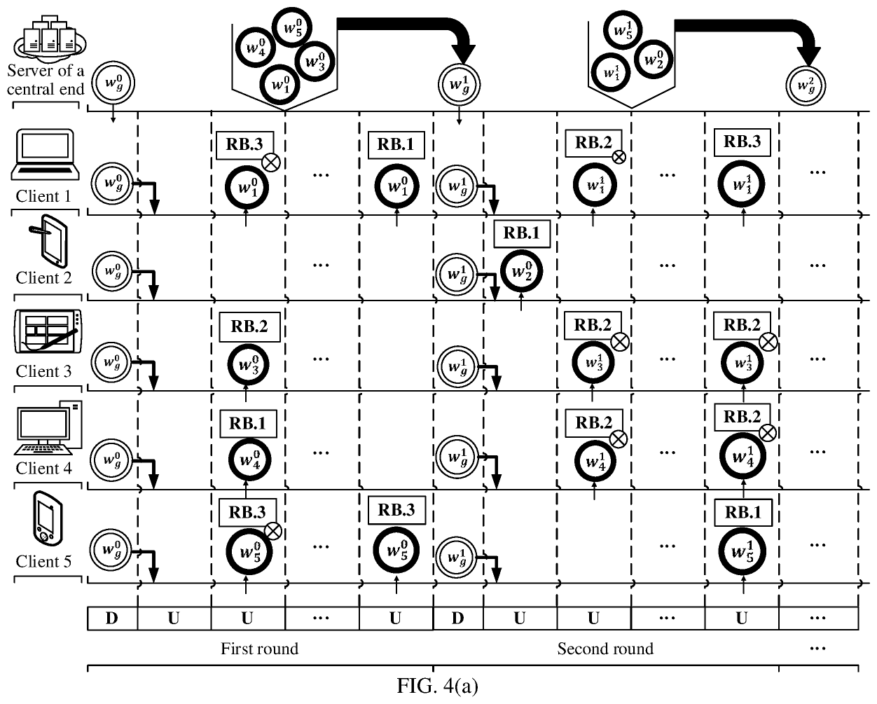

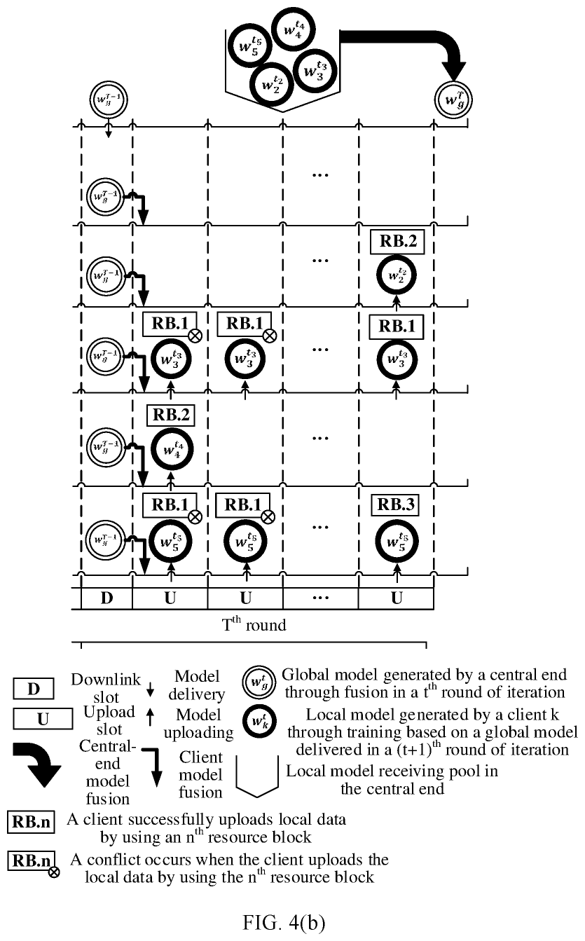

FIG. 4 (a) and FIG. 4 (b) are working sequence diagrams depicting that a central end is triggered, in a manner of setting a count threshold N=3, to perform model fusion in a semi-asynchronous FL system including one central server and five clients according to this application. FIG. 4 (a) is a training process of a first round, a training process of a second round, and a training process before a T^{th} round, and FIG. 4 (b) shows a training process of the T^{th} round and explanations of related parameters and symbols in FIG. 4 (a) and FIG. 4 (b). It can be learned that, in the first round of iteration, a client 2 does not perform training to generate a local model, but performs, in the second round of iteration, training on a global model w_{g}⁰ delivered by the central end in the first round of iteration to generate a local model w₂⁰, and uploads the local model to the central end through a resource block RB.2 for model fusion. In this way, a problem of low training efficiency caused by a synchronization requirement for model uploading versions in a conventional synchronous system can be avoided, and a problem of unstable convergence and a poor generalization capability caused by an “update upon reception” principle of an asynchronous system can be avoided.

Manner two: The central server may alternatively trigger the central-end model fusion in a manner of setting a time threshold (that is, another example of the first threshold).

For example, the system sets a fixed upload slot. For example, L single upload sub-slots are set as an upload slot of one round, and L is greater than or equal to 1. When the upload slot is ended, the central-end model fusion is performed immediately. A central-end model fusion algorithm is the same as that described in Method one, and details are not described herein again.

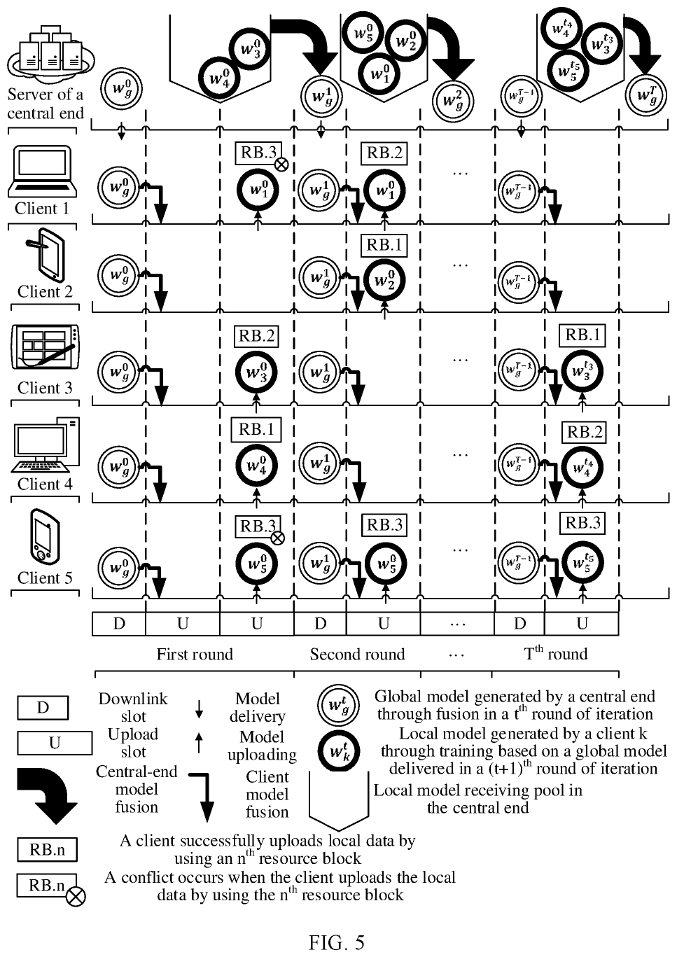

FIG. 5 is a working sequence diagram depicting that a central end is triggered, in a manner of setting a time threshold L=1, to perform model fusion in a semi-asynchronous FL system including one central server and five clients according to this application. It should be noted that, when training starts, because each client cannot complete training instantly (at the beginning of a first upload slot) after receiving an initialized global model, in this application, upload slots in the first round of training are added to two slots, to ensure that the central end can successfully receive at least one local model in the first round. It should be noted that, to ensure that the central end successfully receives the local model in the first round, a quantity of upload slots in the first round needs to be specifically considered based on a latency characteristic of the system. Another alternative solution is to allow the central end to receive no local model in the first round and not to perform a global update simultaneously. In this solution, the system still operates according to an original rule.

It can be learned from FIG. 5 that, in the first round of iteration, a conflict occurs when a client 1 and a client 5 upload local data using a resource block (resource block, RB) 3 (that is, RB.3) in a second upload slot. To ensure that more data information with time validity can be used during central model fusion, reduce collisions during upload, reduce a transmission latency, and improve overall training efficiency, this application provides a scheduling procedure and a slot division rule based on a manner of setting a time threshold.

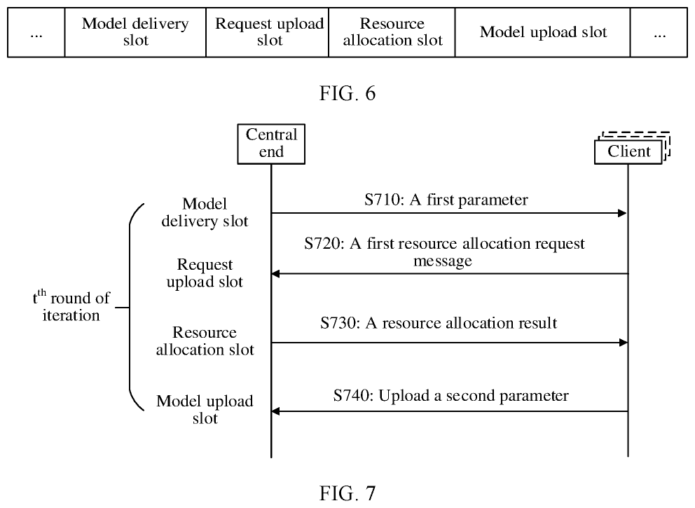

FIG. 6 is a division diagram of system transmission slots that is applicable to this application. FIG. 7 is a flowchart of scheduling system transmission slots according to this application. For example, in FIG. 7, a scheduling procedure of a system transmission slot in the t^{th} round of iteration process is used as an example for description.

S710: In a model delivery slot, for details about an action performed by the central end, refer to S310. Details are not described herein again.

S720: In an upload request slot, when the client k locally includes a local model that has been trained but has not been successfully uploaded, the client k sends a first resource allocation request message to the central end. The first resource allocation request message is for requesting the central end to allocate a resource block to upload the local model that has been trained by the client k, and the first resource allocation request message includes a first version number t′ corresponding to the local model that needs to be uploaded.

Optionally, the first resource allocation request message further includes a device number of the client k.

Correspondingly, the central end receives the first resource allocation request message sent by at least one client.

S730: In a resource allocation slot, the central end sends a resource allocation result to the client.

Correspondingly, the client receives the resource allocation result sent by the central end.

If a quantity of requests of the first resource allocation request message received by the central end in the upload request slot is less than or equal to a total quantity of resource blocks in the system, a resource block is allocated to each client that sends the request, and no conflict occurs in the system; or if a quantity of requests received by the central end is greater than the total quantity of resource blocks in the system, the resources are preferentially allocated to a client that is important for the central model fusion, or preferentially allocated to a client with a better channel condition. For example, each request node may be endowed with a specific sampling probability. Assuming Rₜ is a set of clients that requests allocation of resource blocks in the t^{th} round, a probability that a resource block is allocated to the k^{th} client is:

$${p}_{k} = \frac{{λ}^{t - {t}_{k} - 1} {β}_{k}}{{\sum }_{i ∈ {R}_{t}} {λ}^{t - {t}_{i} - 1} {β}_{i}}$$

A sampling probability of the client k is determined by a product of a quantity of samples of the client k and a proportion of valid information in the to-be-uploaded local model. The indicator may be used to measure, to some extent, a share of useful information that can be provided by the client k after the central end allocates a resource block to the client k. After generating the sampling probability of each requesting client, the central end selects, based on the sampling probability, clients of a quantity that is equal or less than the quantity of resource blocks in the system, and then notifies clients to which the resource blocks are allocated to upload a second parameter in an upload slot of the current round. A client to which resources are not allocated in the current round can initiate a request again in a next round.

S740: In a model upload slot, the at least one client uploads the second parameter based on a resource allocation result of the central end.

Correspondingly, the central end receives the second parameter sent by the at least one client, and then the central end performs version fusion based on the local model in the received second parameter. A fusion algorithm is the same as that described in Method one, and details are not described herein again.

It should be understood that, the foregoing slot scheduling method is not limited to an embodiment of this application, and is applicable to any scenario in which a conflict occurs in transmission slots.

Manner three: The central server may alternatively trigger the central-end model fusion in a manner of combining the count threshold and the time threshold (that is, another example of the first threshold).

For example, the system sets a maximum upload slot. For example, L single upload sub-slots are set as a maximum upload slot of one round of training, L is greater than or equal to 1, and the count threshold N is set simultaneously. When a quantity of the single upload sub-slots does not reach L, if a quantity of local models received by the central end is greater than or equal to N, model fusion is performed immediately. If an upload slot reaches the maximum upload slot, model fusion is performed immediately. A central-end model fusion algorithm is the same as that described in Method one, and details are not described herein again.

S350: Starting from a (t+1)^{th} round of iteration, the central server sends a third parameter to some or all subnodes in the K clients.

The third parameter includes a second global model w_{g}^{j} and a second timestamp t.

Optionally, the third parameter further includes a second contribution vector s^{t}=[s₁^{t},s₂^{t}, . . . sₖ^{t}, . . . , sₖ^{t}], and sₖ^{t} represents a contribution proportion of the client k in the global model w_{g}^{t}.

Then, the central server and the client repeat the foregoing process until the model converges.

In the foregoing technical method, a central end triggers the central model fusion by setting a threshold (the time threshold and/or the count threshold), and in a design of a fusion weight of the central end, a data characteristic included in the local model, a lag degree, and a utilization degree of a data feature of a sample set of a corresponding client are comprehensively considered, so that the semi-asynchronous FL system provided in this application can implement a faster convergence speed than the conventional synchronous FL system.

In the following, this application provides a simulation result of a semi-asynchronous FL system and a conventional synchronous FL system in which all clients participate, and the convergence speeds can be intuitively compared.

It is assumed that the semi-asynchronous FL system includes a single server and 100 clients, the system uses an MNIST dataset including a total of 60,000 data samples of 10 types, and a to-be-trained network is a 6-layer convolutional network. The 60,000 samples are randomly allocated to the clients, and each client has 165 to 1135 samples, and each client has 1 to 5 types of samples. In a training process, a quantity E of local iterations of each round is set to 5 in this application, a version attenuation coefficient λ is set to

$$1 - \frac{N}{K} ,$$

and a bias coefficient φ of an optimization objective is set to

$$\frac{m}{K} ,$$

N is a count threshold preset by the central end, m is a quantity of local models collected by the central end in a corresponding round, and K is a total quantity of clients in the system. Table 1 describes communication parameters in the system.

TABLE 1

| System communication parameters | Values |
|---|---|
| Path loss (dB): Pₗₒₛₛ | 128.1 + 37.6log₁₀ d |
| Channel noise power spectral density: N₀ | −174 dBm. Hz |
| Transmit power of a client/server: P_{c}/Pₛ | 24 dBm/46 dBm |
| Quantity of RBs | 32 |
| Bandwidth of a single RB: B^{U} | 150 KHz |
| System bandwidth: B | 4.8 MHz |
| Quantity of nodes: K | 100 |
| Cell radius: r | 500 m |
| Quantity of model parameters: S | 81990 |
| Bits for single parameter quantization: q | 32 |

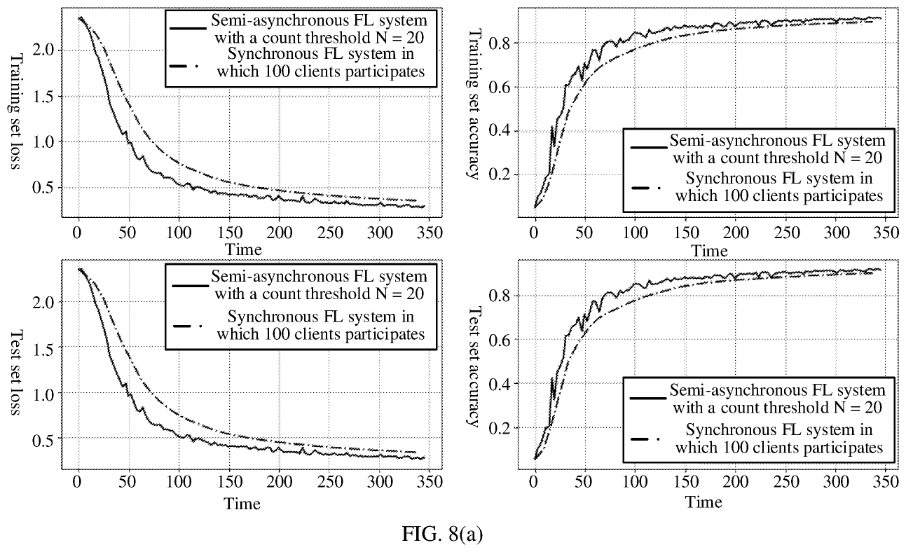

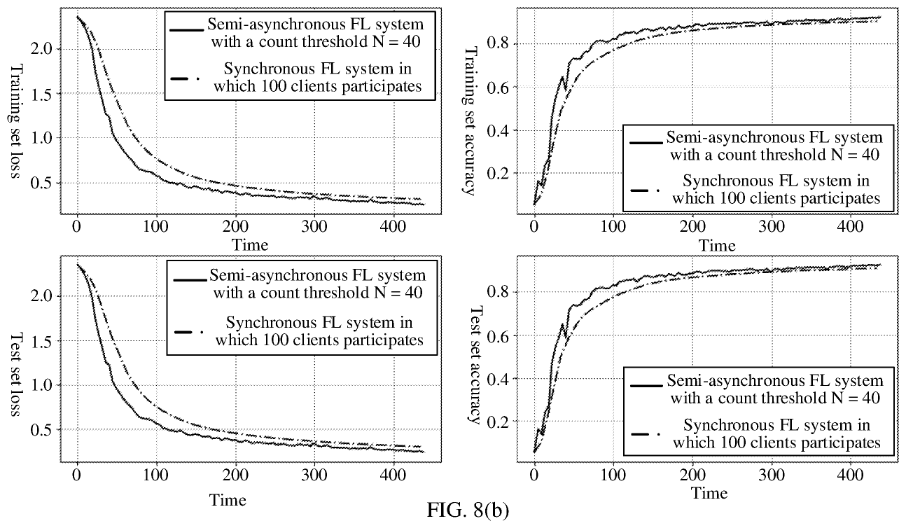

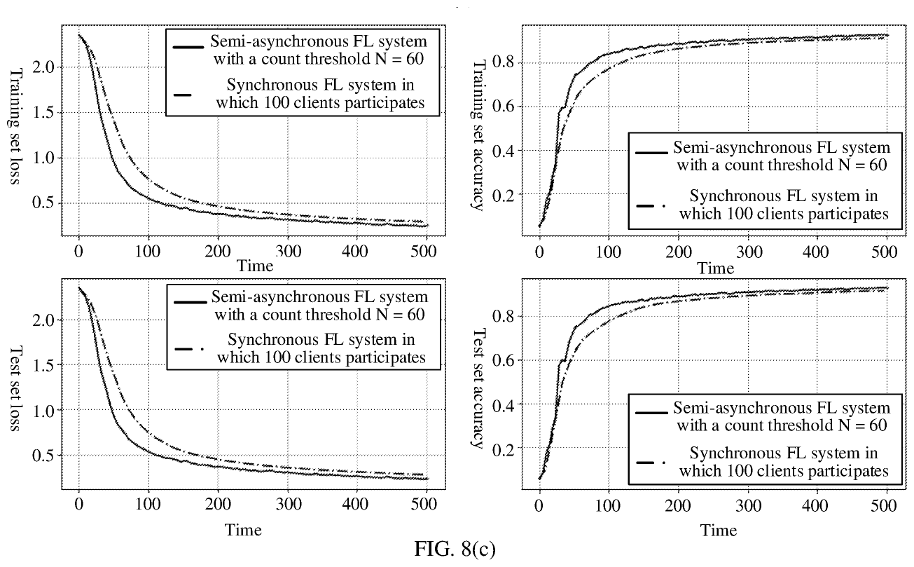

In the semi-asynchronous FL system corresponding to Table 1, a count threshold N is set with reference to the method in Manner one. FIG. 8 (a), FIG. 8 (b), FIG. 8 (c), and FIG. 8 (d) are simulation diagrams of a training set loss and accuracy and a test set loss and accuracy that change with a training time in a semi-asynchronous FL system with a set count threshold N and a conventional synchronous FL framework according to this application. It can be learned from a simulation result that, on the premise that the count threshold N of the local models collected by the service central end in each round is respectively set to 20 (corresponding to FIG. 8 (a)), 40 (corresponding to FIG. 8 (b)), 60 (corresponding to FIG. 8 (c)), and 80 (corresponding to FIG. 8 (d)), in a case that time is used as a reference, the semi-asynchronous FL framework provided in this application has a significant improvement in model convergence speed compared to the conventional synchronous FL system.

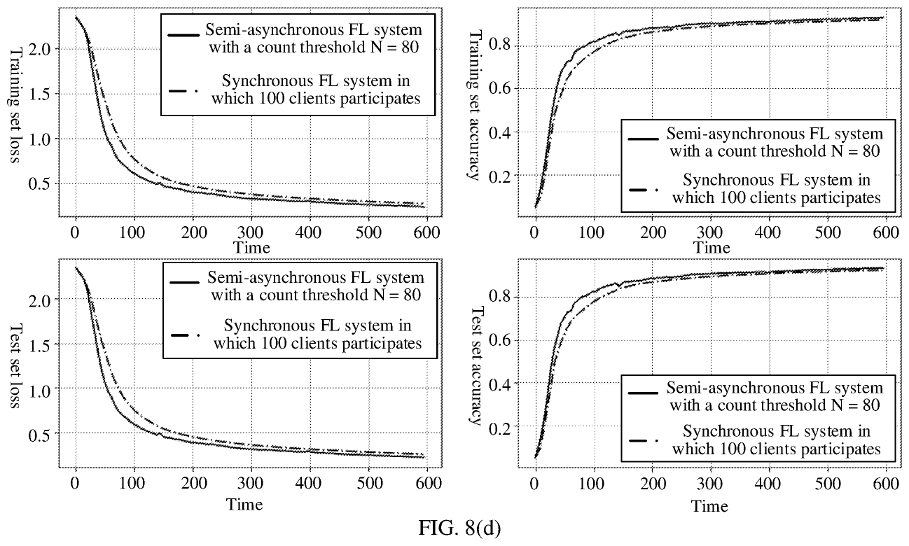

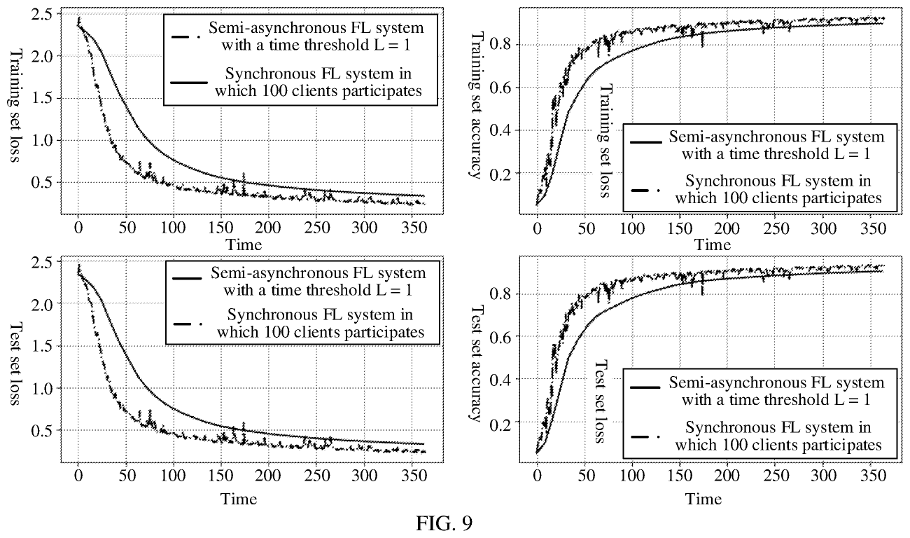

Similarly, in the semi-asynchronous FL system corresponding to Table 1, a time threshold L is set with reference to the method in Manner two. FIG. 9 is a simulation diagram of a training set loss and accuracy and a test set loss and accuracy that change with a training time in a semi-asynchronous federated learning system with a set time threshold L and a conventional synchronous FL framework according to this application. A simulation parameter time threshold is set to L=1. It can be learned from a simulation result that, in a case in which time is used as a reference, the semi-asynchronous FL framework provided in this application also has a significant improvement in model convergence speed compared to the conventional synchronous FL system.

This application provides a system architecture for semi-asynchronous federated learning, to avoid a problem of low training efficiency caused by a synchronization requirement for model uploading versions in the conventional synchronous system, and avoid a problem of unstable convergence and a poor generalization capability caused by an “update upon reception” principle of the asynchronous system. In addition, in the central-end fusion algorithm designed in this application, based on a comprehensive consideration on various factors, each model may be endowed with a proper fusion weight, thereby fully ensuring fast and stable convergence of the model.

The foregoing describes in detail the semi-asynchronous federated learning method provided in this application. The following describes a communication apparatus provided in this application.

FIG. 10 is a schematic block diagram of a communication apparatus 1000 according to this application. As shown in FIG. 10, the communication apparatus 1000 includes a sending unit 1100, a receiving unit 1200, and a processing unit 1300.

The sending unit 1100 is configured to send a first parameter to some or all of K subnodes in a t^{th} round of iteration, where the first parameter includes a first global model and a first timestamp t−1, the first global model is a global model generated by the computing node in a (t−1)^{th} round of iteration, t is an integer greater than or equal to 1, and the K subnodes are all subnodes that participate in model training. The receiving unit 1200 is configured to receive, in the t^{th} round of iteration, a second parameter sent by at least one subnode, where the second parameter includes a first local model and a first version number t′, the first version number indicates that the first local model is generated by the subnode through training, based on a local dataset, a global model received in a (t′+1)^{th} round of iteration, the first version number is determined by the subnode based on a timestamp received in the (t′+1)^{th} round of iteration, 1≤t′+1≤t, and t′ is a natural number. The processing unit 1300 is configured to fuse, according to a model fusion algorithm, m received first local models when a first threshold is reached, to generate a second global model, and update the first timestamp t−1 to a second timestamp t, where m is an integer greater than or equal to 1 and less than or equal to K. The sending unit 1100 is further configured to send a third parameter to some or all subnodes of the K subnodes in a (t+1)^{th} round of iteration, where the third parameter includes the second global model and the second timestamp t.

Optionally, in an embodiment, the first threshold includes a time threshold L and/or a count threshold N, N is an integer greater than or equal to 1, the time threshold L is a preset quantity of time units configured to upload a local model in each round of iteration, and L is an integer greater than or equal to 1. When the first threshold is reached, the processing unit 1300 is specifically configured to: when the first threshold is the count threshold N, fuse, according to the model fusion algorithm, the m first local models received when the first threshold is reached, where m is greater than or equal to the count threshold N; when the first threshold is the time threshold L, fuse, according to the model fusion algorithm, m first local models received in L time units; or when the first threshold includes the count threshold N and the time threshold L, and either threshold of the count threshold N and the time threshold L is reached, fuse the m received first local models according to the model fusion algorithm.

Optionally, in an embodiment, the first parameter further includes a first contribution vector, and the first contribution vector includes contribution proportions of the K subnodes in the first global model. The processing unit 1300 is specifically configured to: determine the first fusion weight based on the first contribution vector, a first sample proportion vector, and the first version number t′ corresponding to the m first local models, where the first fusion weight includes a weight of each local model of them first local models upon model fusion with the first global model, and the first sample proportion vector includes a proportion of a local dataset of each subnode of the K subnodes in all local datasets of the K subnodes; and determine the second global model based on the first fusion weight, the m first local models, and the first global model. The processing unit 1300 is further configured to determine a second contribution vector based on the first fusion weight and the first contribution vector, where the second contribution vector is contribution proportions of the K subnodes in the second global model.

The sending unit 1100 is further configured to send the second contribution vector to some or all subnodes of the K subnodes in the (t+1)^{th} round of iteration.

Optionally, in an embodiment, before the receiving unit 1200 receives, in the t^{th} round of iteration, the second parameter sent by the at least one subnode, the receiving unit 1200 is further configured to receive a first resource allocation request message from the at least one subnode, where the first resource allocation request message includes the first version number t′. When a quantity of the received first resource allocation requests is less than or equal to a quantity of resources in a system, the computing node notifies, based on the first resource allocation request message, the at least one subnode to send the second parameter on an allocated resource; or when a quantity of the received first resource allocation requests is greater than a quantity of resources in a system, the computing node determines based on the first resource allocation request message sent by the at least one subnode and the first proportion vector, a probability for a resource being allocated to each subnode of the at least one subnode. The processing unit 1300 is further configured to determine, based on the probability, to use a subnode of a resource in the system from the at least one subnode. The sending unit 1100 is further configured to give a notification of determining to use the subnode of the resource in the system to send the second parameter on an allocated resource.

Optionally, the sending unit 1100 and the receiving unit 1200 may alternatively be integrated into a transceiver unit, which has both a receiving function and a sending function. This is not limited herein.

In an implementation, the communication apparatus 1000 may be the computing node in the method embodiments. In this implementation, the sending unit 1100 may be a transmitter, and the receiving unit 1200 may be a receiver. Alternatively, the receiver and the transmitter may be integrated into a transceiver. The processing unit 1300 may be a processing apparatus.

In another implementation, the communication apparatus 1000 may be a chip or an integrated circuit mounted in the computing node. In this implementation, the sending unit 1100 and the receiving unit 1200 may be communication interfaces or interface circuits. For example, the sending unit 1100 is an output interface or an output circuit, the receiving unit 1200 is an input interface or an input circuit, and the processing unit 1300 may be a processing apparatus.

A function of the processing apparatus may be implemented by hardware, or may be implemented by hardware executing corresponding software. For example, the processing apparatus may include a memory and a processor. The memory is configured to store a computer program, the processor reads and executes the computer program stored in the memory, the communication apparatus 1000 is enabled to perform operations and/or processing performed by the computing node in the method embodiments. Optionally, the processing apparatus may include only the processor, and the memory configured to store the computer program is located outside the processing apparatus. The processor is connected to the memory through a circuit/wire, to read and execute the computer program stored in the memory. For another example, the processing apparatus may be a chip or an integrated circuit.

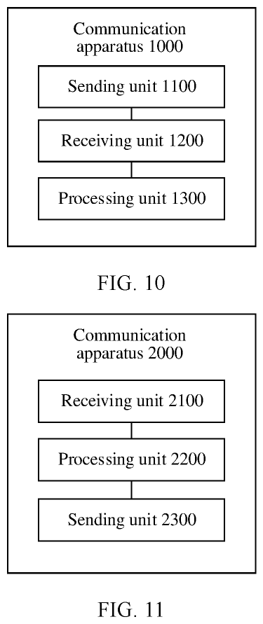

FIG. 11 is a schematic block diagram of a communication apparatus 2000 according to this application. As shown in FIG. 11, the communication apparatus 2000 includes a receiving unit 2100, a processing unit 2200, and a sending unit 2300.

The receiving unit 2100 is configured to receive a first parameter from a computing node in a t^{th} round of iteration, where the first parameter includes a first global model and a first timestamp t−1, the first global model is a global model generated by the computing node in a (t−1)^{th} round of iteration, and t is an integer greater than 1. The processing unit 2200 is configured to train, based on a local dataset, the first global model or a global model received before the first global model, to generate a first local model. The sending unit 2300 is configured to send a second parameter to the computing node in the t^{th} round of iteration, where the second parameter includes the first local model and a first version number t′, the first version number indicates that the first local model is generated by the subnode through training, based on the local dataset, a global model received in a (t′+1)^{th} round of iteration, the first version number is determined by the subnode based on a timestamp received in the (t′+1)^{th} round of iteration, 1≤t′+1≤t, and t′ is a natural number. The receiving unit 2100 is configured to receive, a third parameter from the computing node in a (t+1)^{th} round of iteration, where the third parameter includes the second global model and a second timestamp t.

Optionally, in an embodiment, the processing unit 2200 is specifically configured to: when the processing unit 2200 is in an idle state, train the first global model based on the local dataset, to generate the first local model; or when the processing unit 2200 is training a third global model, and the third global model is the global model received before the first global model, based on an impact proportion of the subnode in the first global model, choose to continue training the third global model to generate the first local model, or choose to start training the first global model to generate the first local model; or the first local model is a newest local model in at least one local model that is locally stored by the subnode and that has been trained but has not been successfully uploaded.

Optionally, in an embodiment, the first parameter further includes a first contribution vector, and the first contribution vector is contribution proportions of the K subnodes in the first global model. The processing unit 2200 is specifically configured to: When a ratio of a contribution proportion of the subnode in the first global model to a sum of the contribution proportions of the K subnodes in the first global model is greater than or equal to the first sample proportion, the processing unit stops training the third global model, and starts training the first global model, where the first sample proportion is a ratio of the local dataset of the subnode to all local datasets of the K subnodes; or when a ratio of a contribution proportion of the subnode in the first global model to a sum of the contribution proportions of the K subnodes in the first global model is less than the first sample proportion, the processing unit 2200 continues training the third global model. The receiving unit 2100 is further configured to receive the second contribution vector from the computing node in the (t+1)^{th} round of iteration, where the second contribution vector is contribution proportions of the K subnodes in the second global model.

Optionally, in an embodiment, before the sending unit 2300 sends the second parameter to the computing node in the t^{th} round of iteration, the sending unit 2300 is further configured to send a first resource allocation request message to the computing node, where the first resource allocation request message includes the first version number t′. The receiving unit 2100 is further configured to receive a notification about a resource allocated by the computing node, and the sending unit 2300 is further configured to send the second parameter on the allocated resource based on the notification.

Optionally, the receiving unit 2100 and the sending unit 2300 may alternatively be integrated into a transceiver unit, which has both a receiving function and a sending function. This is not limited herein.

In an implementation, the communication apparatus 2000 may be the subnode in the method embodiments. In this implementation, the sending unit 2300 may be a transmitter, and the receiving unit 2100 may be a receiver. Alternatively, the receiver and the transmitter may be integrated into a transceiver. The processing unit 2200 may be a processing apparatus.

In another implementation, the communication apparatus 2000 may be a chip or an integrated circuit mounted in the subnode. In this implementation, the sending unit 2300 and the receiving unit 2100 may be communication interfaces or interface circuits. For example, the sending unit 2300 is an output interface or an output circuit, the receiving unit 2100 is an input interface or an input circuit, and the processing unit 2200 may be a processing apparatus.

A function of the processing apparatus may be implemented by hardware, or may be implemented by hardware executing corresponding software. For example, the processing apparatus may include a memory and a processor. The memory is configured to store a computer program, the processor reads and executes the computer program stored in the memory, the communication apparatus 2000 is enabled to perform operations and/or processing performed by the subnode in the method embodiments. Optionally, the processing apparatus may include only the processor, and the memory configured to store the computer program is located outside the processing apparatus. The processor is connected to the memory through a circuit/wire, to read and execute the computer program stored in the memory. For another example, the processing apparatus may be a chip or an integrated circuit.

FIG. 12 is a schematic diagram of a structure of a communication apparatus 10 according to this application. As shown in FIG. 12, the communication apparatus 10 includes one or more processors 11, one or more memories 12, and one or more communication interfaces 13. The processor 11 is configured to control the communication interface 13 to send and receive a signal. The memory 12 is configured to store a computer program. The processor 11 is configured to invoke the computer program from the memory 12 and run the computer program, to perform procedures and/or operations performed by the computing node in the method embodiments of this application.

For example, the processor 11 may have functions of the processing unit 1300 shown in FIG. 10, and the communication interface 13 may have functions of the sending unit 1100 and/or the receiving unit 1200 shown in FIG. 10. Specifically, the processor 11 may be configured to perform processing or operations internally performed by the computing node in the method embodiments of this application, and the communication interface 13 is configured to perform a sending and/or receiving action performed by the computing node in the method embodiments of this application.

In an implementation, the communication apparatus 10 may be the computing node in the method embodiments. In this implementation, the communication interface 13 may be a transceiver. The transceiver may include a receiver and a transmitter.

Optionally, the processor 11 may be a baseband apparatus, and the communication interface 13 may be a radio frequency apparatus.

In another implementation, the communication apparatus 10 may be a chip mounted in the computing node. In this implementation, the communication interface 13 may be an interface circuit or an input/output interface.

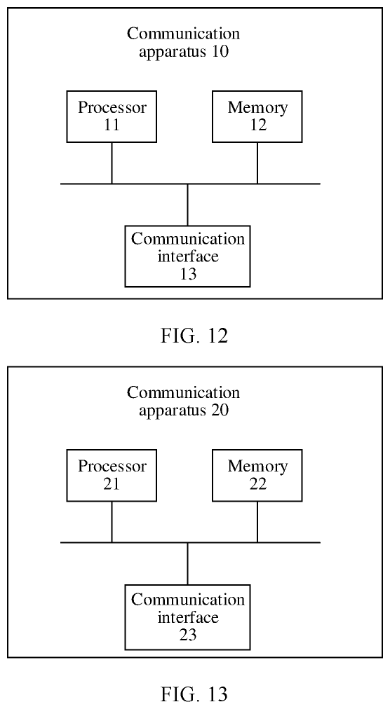

FIG. 13 is a schematic diagram of a structure of a communication apparatus 20 according to this application. As shown in FIG. 13, the communication apparatus 20 includes one or more processors 21, one or more memories 22, and one or more communication interfaces 23. The processor 21 is configured to control the communication interface 23 to send and receive a signal. The memory 22 is configured to store a computer program. The processor 21 is configured to invoke the computer program from the memory 22 and run the computer program, to perform procedures and/or operations performed by the subnode in the method embodiments of this application.

For example, the processor 21 may have functions of the processing unit 2200 shown in FIG. 11, and the communication interface 23 may have functions of the sending unit 2300 and the receiving unit 2100 shown in FIG. 11. Specifically, the processor 21 may be configured to perform processing or operations internally performed by the subnode in the method embodiments of this application, and the communication interface 23 is configured to perform a sending and/or receiving action performed by the subnode in the method embodiments of this application. Details are not described again.

Optionally, the processor and the memory in the foregoing apparatus embodiments may be physically independent units. Alternatively, the memory may be integrated with the processor. This is not limited in this specification.

In addition, this application further provides a computer-readable storage medium. The computer-readable storage medium stores computer instructions, and when the computer instructions are run on a computer, operations and/or procedures performed by the computing node in the method embodiments of this application are performed.

This application further provides a computer-readable storage medium. The computer-readable storage medium stores computer instructions, and when the computer instructions are run on a computer, operations and/or procedures performed by the subnode in the method embodiments of this application are performed.

This application further provides a computer program product. The computer program product includes computer program code or instructions, and when the computer program code or the instructions are run on a computer, operations and/or procedures performed by the computing node in the method embodiments of this application are performed.

This application further provides a computer program product. The computer program product includes computer program code or instructions, and when the computer program code or the instructions are run on a computer, operations and/or procedures performed by the subnode in the method embodiments of this application are performed.

In addition, this application further provides a chip. The chip includes a processor. A memory configured to store a computer program is disposed independent of the chip. The processor is configured to execute the computer program stored in the memory, to perform operations and/or processing performed by the computing node in any method embodiment.

Further, the chip may include a communication interface. The communication interface may be an input/output interface, an interface circuit, or the like. Further, the chip may include the memory.

This application further provides a chip including a processor. A memory configured to store a computer program is disposed independent of the chip. The processor is configured to execute the computer program stored in the memory, to perform operations and/or processing performed by the subnode in any method embodiment.

Further, the chip may include a communication interface. The communication interface may be an input/output interface, an interface circuit, or the like. Further, the chip may include the memory.

In addition, this application further provides a communication system, including the computing node and the subnode in embodiments of this application.

The processor in embodiments of this application may be an integrated circuit chip, and has a signal processing capability. In an implementation process, steps in the foregoing method embodiments can be implemented by a hardware integrated logical circuit in the processor, or by instructions in a form of software. The processor may be a general-purpose processor, a digital signal processor (digital signal processor, DSP), an application-specific integrated circuit (application-specific integrated circuit, ASIC), a field programmable gate array (field programmable gate array, FPGA) or another programmable logic device, a discrete gate or a transistor logic device, or a discrete hardware component. The general-purpose processor may be a microprocessor, or the processor may be any conventional processor or the like. The steps of the methods disclosed in embodiments of this application may be directly presented as being performed and completed by a hardware encoding processor, or performed and completed by a combination of hardware and a software module in an encoding processor. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the steps in the foregoing methods in combination with hardware of the processor.

The memory in embodiments of this application may be a volatile memory or a non-volatile memory, or may include both a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), and is used as an external cache. Through example but not limitative description, RAMs in many forms are available, such as a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DRRAM). It should be noted that the memory of the systems and methods described in this specification includes but is not limited to these and any memory of another proper type.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units are integrated into one unit.

The term “and/or” in this application describes only an association relationship between associated objects and represents that three relationships may exist. For example, A and/or B may represent the following three cases: Only A exists, both A and B exist, and only B exists. A, B, and C each may be singular or plural. This is not limited.

When the functions are implemented in the form of a software functional unit and sold or used as an independent product, the functions may be stored in a computer-readable storage medium. Based on such an understanding, the technical solutions of this application essentially, or the part contributing to the prior art, or some of the technical solutions may be implemented in a form of a software product. The computer software product is stored in a storage medium, and includes several instructions for instructing a computer device (which may be a personal computer, a server, or a network device) to perform all or some of the steps of the methods described in embodiments of this application. The foregoing storage medium includes any medium that can store program code, such as a USB flash drive, a removable hard disk, a ROM, a RAM, a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method for semi-asynchronous federated learning, comprising:
sending, by a computing node, a first parameter to some or all of K subnodes in a t^{th} round of iteration, wherein the first parameter comprises a first global model and a first timestamp t−1, the first global model is a global model generated by the computing node in a (t−1)^{th} round of iteration, t is an integer greater than or equal to 1, and the K subnodes are subnodes that participate in model training;
receiving, by the computing node in the t^{th} round of iteration, a second parameter sent by at least one subnode, wherein the second parameter comprises a first local model and a first version number t′, the first version number t′ indicates that the first local model is generated by the subnode through training, based on a local dataset, a global model received in a (t′+1)^{th} round of iteration, the first version number is determined by the subnode based on a timestamp received in the (t′+1)^{th} round of iteration, t′+1 is greater than or equal to 1 and less than or equal to t, and t′ is a natural number;
fusing, by the computing node according to a model fusion algorithm, m received first local models when a first threshold is reached, to generate a second global model, and updating the first timestamp t−1 to a second timestamp t, wherein m is an integer greater than or equal to 1 and less than or equal to K; and
sending, by the computing node, a third parameter to some or all subnodes of the K subnodes in a (t+1)^{th} round of iteration, wherein the third parameter comprises the second global model and the second timestamp t.

2. The method according to claim 1, wherein the first threshold comprises a time threshold L and/or a count threshold N, N is an integer greater than or equal to 1, the time threshold L is a preset quantity of time units configured to upload a local model in each round of iteration, and L is an integer greater than or equal to 1.

3. The method according to claim 2, wherein the fusing, by the computing node according to a model fusion algorithm, m received first local models when a first threshold is reached comprises:
when the first threshold is the count threshold N, fusing, by the computing node according to the model fusion algorithm, the m first local models received when the first threshold is reached, wherein m is greater than or equal to the count threshold N; and
when the first threshold is the time threshold L, fusing, by the computing node according to the model fusion algorithm, m first local models received in L time units; or
when the first threshold comprises the count threshold N and the time threshold L, and either threshold of the count threshold N and the time threshold L is reached, fusing, by the computing node according to the model fusion algorithm, the m received first local models.

4. The method according to claim 1, wherein the first parameter further comprises a first contribution vector, and the first contribution vector comprises contribution proportions of the K subnodes in the first global model.

5. The method according to claim 4, wherein the fusing, by the computing node according to a model fusion algorithm, m received first local models, to generate a second global model comprises:
determining, by the computing node, a first fusion weight based on the first contribution vector, a first sample proportion vector, and the first version number t′ corresponding to the m first local models, wherein the first fusion weight comprises a weight of each local model of the m first local models upon model fusion with the first global model, and the first sample proportion vector comprises a proportion of a local dataset of each subnode of the K subnodes in all local datasets of the K subnodes; and
determining, by the computing node, the second global model based on the first fusion weight, the m first local models, and the first global model.

6. The method according to claim 5, further comprising:
determining, by the computing node, a second contribution vector based on the first fusion weight and the first contribution vector, wherein the second contribution vector is contribution proportions of the K subnodes in the second global model; and
sending, by the computing node, the second contribution vector to some or all subnodes of the K subnodes in the (t+1)^{th} round of iteration.

7. The method according to claim 1, wherein before the receiving, by the computing node in the t^{th} round of iteration, a second parameter sent by at least one subnode, the method further comprises:
receiving, by the computing node, a first resource allocation request message from the at least one subnode, wherein the first resource allocation request message comprises the first version number t′;
when a quantity of the first resource allocation requests received by the computing node is less than or equal to a quantity of resources in a system, notifying, by the computing node based on the first resource allocation request message, the at least one subnode to send the second parameter on an allocated resource; or
when a quantity of the first resource allocation requests received by the computing node is greater than a quantity of resources in a system, determining, by the computing node based on the first resource allocation request message sent by the at least one subnode and the first proportion vector, a probability for a resource being allocated to each subnode of the at least one subnode;
determining, by the computing node, a resource allocation result based on the probability; and
sending, by the computing node, the resource allocation result to the at least one subnode.

8. A communication apparatus, comprising:
a memory;
a processor coupled to the memory and configured to
send a first parameter to some or all of K subnodes in a t^{th} round of iteration, wherein the first parameter comprises a first global model and a first timestamp t−1, the first global model is a global model generated by the computing node in a (t−1)^{th} round of iteration, t is an integer greater than or equal to 1, and the K subnodes are all subnodes that participate in model training;
receive, in the t^{th} round of iteration, a second parameter sent by at least one subnode, wherein the second parameter comprises a first local model and a first version number t′, the first version number indicates that the first local model is generated by the subnode through training, based on a local dataset, a global model received in a (t′+1)^{th} round of iteration, the first version number is determined by the subnode based on a timestamp received in the (t′+1)^{th} round of iteration, 1≤t′+1≤t, and t′ is a natural number; and
fuse, according to a model fusion algorithm, m received first local models when a first threshold is reached, to generate a second global model, and update the first timestamp t−1 to a second timestamp t, wherein m is an integer greater than or equal to 1 and less than or equal to K; and
send a third parameter to some or all subnodes of the K subnodes in a (t+1)^{th} round of iteration, wherein the third parameter comprises the second global model and the second timestamp t.

9. The communication apparatus according to claim 8, wherein the first threshold comprises a time threshold L and/or a count threshold N, N is an integer greater than or equal to 1, the time threshold L is a preset quantity of time units configured to upload a local model in each round of iteration, and L is an integer greater than or equal to 1; or
when the first threshold is the count threshold N, the processing unit is specifically configured to, when the first threshold is reached, fuse, according to the model fusion algorithm, the m first local models received when the first threshold is reached, wherein m is greater than or equal to the count threshold N;
when the first threshold is the time threshold L, the processing unit is specifically configured to, when the first threshold is reached, fuse, according to the model fusion algorithm, m first local models received in L time units; or
when the first threshold comprises the count threshold N and the time threshold L, and either threshold of the count threshold N and the time threshold L is reached, fuse the m received first local models according to model fusion algorithm.

10. The communication apparatus according to claim 8, wherein the first parameter further comprises a first contribution vector, and the first contribution vector comprises contribution proportions of the K subnodes in the first global model.

11. The communication apparatus according to claim 10, wherein the processor is further configured to: determine the first fusion weight based on the first contribution vector, a first sample proportion vector, and the first version number t′ corresponding to the m first local models, wherein the first fusion weight comprises a weight of each local model of the m first local models upon model fusion with the first global model, and the first sample proportion vector comprises a proportion of a local dataset of each subnode of the K subnodes in all local datasets of the K subnodes;
determine the second global model based on the first fusion weight, the m first local models, and the first global model;
determine a second contribution vector based on the first fusion weight and the first contribution vector, wherein the second contribution vector is contribution proportions of the K subnodes in the second global model; and
send the second contribution vector to some or all subnodes of the K subnodes in the (t+)^{th} round of iteration.

12. The communication apparatus according to claim 8, wherein before the processor is configured to receive, in the t^{th} round of iteration, the second parameter sent by the at least one subnode,
the processor is further configured to receive a first resource allocation request message from the at least one subnode, wherein the first resource allocation request message comprises the first version number t′;
when a quantity of the first resource allocation requests received by the computing node is less than or equal to a quantity of resources in a system, notify, based on the first resource allocation request message, the at least one subnode to send the second parameter on an allocated resource; or
when a quantity of the first resource allocation requests received by the computing node is greater than a quantity of resources in a system, determine, based on the first resource allocation request message sent by the at least one subnode and the first proportion vector, a probability for a resource being allocated to each subnode of the at least one subnode;
determine a resource allocation result based on the probability; and
send the resource allocation result to the at least one subnode.

13. A non-transitory computer-readable storage medium storing computer instructions, that when executed by one or more processors, cause the one or more processors to perform steps of:
sending a first parameter to some or all of K subnodes in a t^{th} round of iteration, wherein the first parameter comprises a first global model and a first timestamp t−1, the first global model is a global model generated by the computing node in a (t−1)^{th} round of iteration, t is an integer greater than or equal to 1, and the K subnodes are subnodes that participate in model training;
receiving a second parameter sent by at least one subnode, wherein the second parameter comprises a first local model and a first version number t′, the first version number t′ indicates that the first local model is generated by the subnode through training, based on a local dataset, a global model received in a (t′+1)^{th} round of iteration, the first version number is determined by the subnode based on a timestamp received in the (t′+1)^{th} round of iteration, t′+1 is greater than or equal to 1 and less than or equal to t, and t′ is a natural number;
fusing m received first local models when a first threshold is reached, to generate a second global model, and updating the first timestamp t−1 to a second timestamp t, wherein m is an integer greater than or equal to 1 and less than or equal to K; and
sending a third parameter to some or all subnodes of the K subnodes in a (t+1)^{th} round of iteration, wherein the third parameter comprises the second global model and the second timestamp t.

14. The non-transitory computer-readable storage medium according to claim 13, wherein the first threshold comprises a time threshold L and/or a count threshold N, N is an integer greater than or equal to 1, the time threshold L is a preset quantity of time units configured to upload a local model in each round of iteration, and L is an integer greater than or equal to 1.

15. The non-transitory computer-readable storage medium according to claim 14, wherein the one or more processors further execute the computer instructions to cause the one or more processors to perform the step of fusing m received first local models when a first threshold is reached by
when the first threshold is the count threshold N, fusing, by the computing node according to the model fusion algorithm, the m first local models received when the first threshold is reached, wherein m is greater than or equal to the count threshold N; and
when the first threshold is the time threshold L, fusing, by the computing node according to the model fusion algorithm, m first local models received in L time units; or
when the first threshold comprises the count threshold N and the time threshold L, and either threshold of the count threshold N and the time threshold L is reached, fusing, by the computing node according to the model fusion algorithm, the m received first local models.
